(19) United States
(12) Patent Application Publication
(10) Pub. No.: US 2005/0255250 A1
(43) Pub. Date: Nov. 17, 2005

(54) Method and device for producing parts having a sealing layer on the surface, and corresponding parts

(76) Inventors: Klaus Becker-Weimann, Karlsruhe (DE); Oliver Buker, Marxzell-Burbach (DE); Uwe Schroeder, Marxzell-Schielberg (DE)

Correspondence Address: John F Hoffman;Baker & Daniels, 111 East Wayne Street, Suite 800, Fort Wayne, IN, 46802, US

(21) Appl. No.: 10/478,143

(22) PCT Filed: May 16, 2002
(86) PCT No.: PCT/DE02/01771

§ 371 Date: May 10, 2005

(30) Foreign Application Priority Data
May 18, 2001 (DE) 101 24 676.5

(51) Int. Cl. B05D 3/02

(52) U.S. Cl. 427/377

(57) ABSTRACT

The invention relates to a method and a device for producing parts (1) having a sealing layer (2) on the surface, and corresponding parts. Said method and device are improved in that the sealing layer (2) is applied to the surface in the form of a water-free and solvent-free reactive hot melt layer based on polyurethane and hardened by atmospheric humidity, and the inventive device comprises an application station (6), a transport device (5) and a smoothing station (8).

The invention relates to a method for producing parts having a sealing layer on the surface and corresponding parts.

Paints are currently being used as sealing layers on the surface of a large number of parts in various areas of application, for example, in the furniture and wood-processing industry, but also for parts made of steel, nonferrous metals, plastic, paper, cardboard, papier-mâché, or mineral substances. UV-hardening paints, usually applied to the parts by means of a roller, less often by spraying, are a widespread system for painting. The subsequent curing process takes place using UV light or UV lamps. The mechanical effort during painting with UV paints is very high and requires a lot of space. The reason for the large spatial requirement is also that painting processes with UV-hardening systems usually require more coats: three to four coats are normally required. Due to the viscosity and especially the full UV hardening, each coat of paint can only be applied in ca. 10 to 20 my layers, which is also why several coats of paint are necessary. UV lamps and the necessary energy for the curing are very expensive.

Other paint systems, e.g. 2-K-PUR paints, nitrocellulose lacquers, or water lacquers must also be applied in several layers. Fillers, primers, and, if necessary, intermediate coats are also always required and make the surface coating a process that is complex and mechanically very costly and expensive.

It is known from DE 198 06 136 C2 that a board for a parquet floor is provided with a least one layer of wood and one sealing layer on its surface should be formed so that the sealing layer is made of a water-free and solvent-free reactive hot melt layer based on polyurethane and hardened by atmospheric humidity. The reactive hot melt layer is thereby blade-coated, rolled, or sprayed onto the layer of wood. This coat can lead to undesired unevenness in the sealing layer. Moreover, the reactive hot melt layer can still be sticky after it has been applied so that the sealing layer can be damaged when handling the parquet-board semi-finished products or the individual parts can stick to each other when stacked. In practice, the cooling zone suggested in DE 198 06 136 C2 is associated with high costs for the preparation of the very cold, humid air.

The purpose of this invention is to advantageously advance the state of the art.

This purpose is fulfilled with the characteristics of the independent claims.

First, it is recognized that a water-free and solvent-free reactive hot melt layer based on polyurethane and hardened by atmospheric humidity can also be used for the formation of a sealing layer on various other types of materials in order to advantageously replace the previous paints. This is also the case with furniture parts that are made of solid wood or veneered parts with a wood or derived-timber product base material and adhered veneer. In addition to this, such a reactive hot melt layer can also be used for the sealing of wood-like materials, parts made of steel, nonferrous metals, plastic, paper, cardboard, or mineral substances. With all of these different types of materials, a single coat without intermediate treatment in the form of polishing, precipitation, or similar can be formed with a sealing layer with coat strengths between 5 and 150 my that has a very high resistance to attrition, high tenacity and scratch resistance, good shock resistance and residual elasticity for avoiding brittle breaks, high chemical resistance, and, depending on the requirements and demands, good UV resistance. In addition, this type of surface finishing is mechanically easy and thus more economical.

In addition to this, for all parts with a sealing layer on their surface that is a water-free and solvent-free reactive hot melt layer based on polyurethane and hardened by atmospheric humidity, an improvement can be made in surface properties in that, after being applied to the surface of the part, the reactive hot melt layer is smoothed. Unevennesses in the surface that can result from the mere coating of the hot reactive melt layer are thereby avoided and an even smoother surface is created. Then, it is also possible to work with less amounts of material, between 70 and 100 g/m² of the reactive hot melt.

The water-free and solvent-free reactive hot melt layer is applied to the surface to be sealed at a temperature above 100° C., approx. 100° C. to 140° C. In this process, approx. 70 to 100 g of the reactive hot melt is applied per square meter of surface to be sealed. The reactive hot melt usually has a thickness of ca. 1.1 g/m² and a viscosity, according to Brookfield, at 120° C. of ca. 4,000 mPas and at 140° C. of ca. 2,400 mPas. It is a good idea to apply the reactive hot melt layer while the part is hermetically sealed and protected from humidity in order to prevent a premature response. For example, the layer can be blade-coated, rolled on, sprayed on or applied by means of a nozzle or fan nozzle. Even in a hardened state as a 100% solid body, the reactive hot melt layer still has a certain residual elasticity.

Before any potential further processing of the surface-coated parts, the parts should be able to cross-link for 3 to 5 days depending on humidity, so that a nearly complete cross-linking occurs to prevent surface scratches. With pieces of laminated parquet, further processing can be performed, for example, by profiling of the tongue-and-groove joints. Other parts might also require further processing, or the production process ends with the coating of the surface in accordance with the invention.

With the methods in accordance with the invention, various types of parts can be produced. Besides boards for parquet floors, furniture parts or other parts made of wood-like material can also be produced in accordance with the invention. In addition to this, steel parts and parts made of nonferrous metals, plastic, paper, cardboard, papier-mâché, and mineral substances can also be coated. Other areas of application for the surface coating are also possible.

It is advantageous to once again apply heat to the surface of the reactive hot melt layer between the application and the smoothing in order to further improve the result of the smoothing. Conveniently, the smoothing occurs by means of a roller, for example, a steel roller, which can be provided with a polyurethane coating.

It is particularly advantageous if the roller is wetted with a separating agent during the smoothing. In this manner, it is effectively prevented that the as-yet-unhardened reactive hot melt layer comes off the part to be sealed and sticks to the roller. Preferably, the separating agent is applied as a solvent-free and low-viscosity substance based on paraffin wax. Such a substance, for one, prevents the reactive hot melt layer from sticking to the roller, and, moreover, the surface of the reactive hot melt surface will be considerably smoother and immediately block-free. An increase in the degree of luster of the finished sealing layer is also achievable with this separating agent. The separating agent based on paraffin wax is clear and has a thickness of ca. 0.85 g/cm² as well as a viscosity at 20° C., according to Brookfield, of ca. 34 mPas. The coating amount is ca. 20 to 35 g/m².

The separating agent is, for example, applied to the roller by a spraying procedure or a vacuum spraying procedure. However, it is preferred that the separating agent is applied to the roller by means of a saturated felting, which represents a particularly easy and secure option for obtaining an even, thin separating agent film during the smoothing of the reactive hot melt layer.

A device for producing parts with a sealing layer on their surface contains an application station, a transport device, and a smoothing station. It is a good idea to arrange a heating device between the application station and the smoothing station.

In a preferred version of the device, the smoothing station contains at least one roller, for example, a steel roller, and has a polyurethane coating. Moreover, it also advantageous if the roller can be wetted with a separating agent. This separating agent is, for example, a substance based on paraffin wax. A spray device or a saturated felting, for example, can be provided for the wetting of the roller with the separating agent.

The invention is explained in the drawing by means of a sample version. The drawing shows the following:

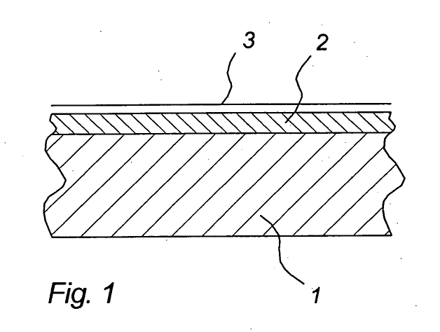

FIG. 1 shows a schematically represented section of a part in accordance with the invention with a sealing layer on the surface.

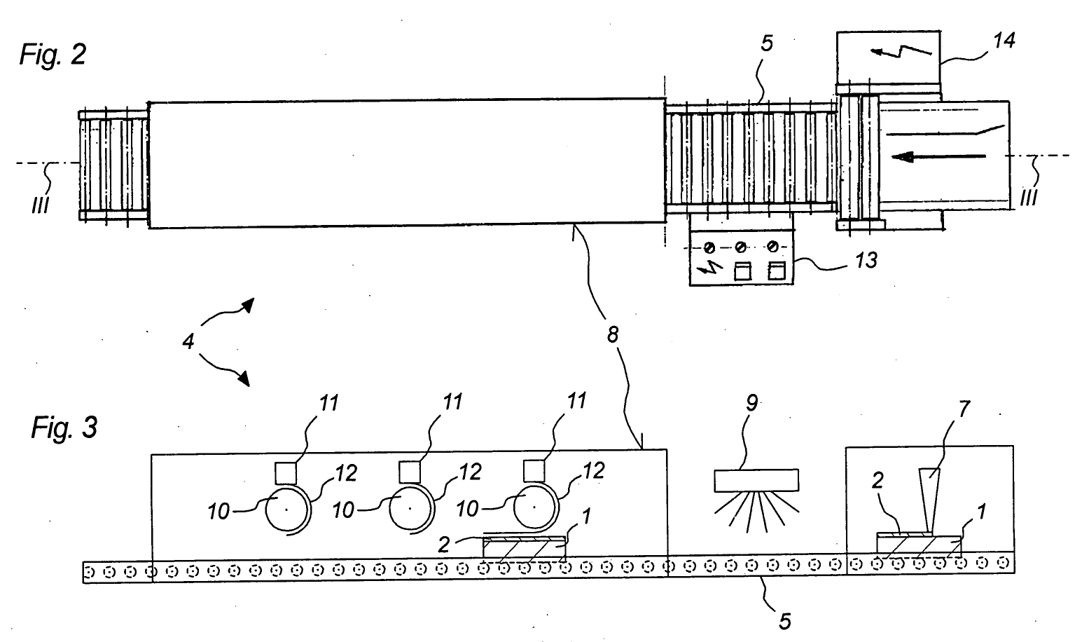

FIG. 2 shows a view of a production line for parts in accordance with the invention. and

FIG. 3 shows a cut along the line III-III of FIG. 2.

FIG. 1 shows a section of any part 1, for example, a board for a parquet floor. In the case of a board for a parquet floor, the actual board normally consists of several layers not shown in the drawing, namely at least one outer layer made of wood, which is glued with one or several sub-layers. But, it could also be a section of a piece of furniture, which can be made of solid wood or veneered parts with a wood or derived-timber product base material and adhered veneer, or wood-like products, parts made of steel, nonferrous metals, plastic, paper, cardboard, papier-mâché, or mineral substances.

There is a sealing layer 2 made of a water-free and solvent-free reactive hot melt layer based on polyurethane and hardened by atmospheric humidity on the topside of part 1 that is smoothed during production by means of a roller wetted with a paraffin-based separating agent. This smoothing process creates a particularly smooth surface for the sealing layer, which is indicated by line 3.

FIGS. 2 and 3 show a schematically represented production line 4 for the continuous production of parts in accordance with the invention. The production line 4 contains a transport device 5 for the parts to be coated. The reactive hot melt layer is heated to at least 100° C. in application station 6 while hermetically sealed and protected from humidity; it is then pumped into a pumping device (not shown) via a heated hose, fed through the hose to an application device, for example, a fan nozzle, and applied to part 1 using the fan nozzle. The production line and its components are controlled by the indicated control unit 13. Moreover, a schematic drive unit 14 is indicated for the transport device 5.

The part 1 coated with the reactive hot melt is transported from the application station to the setting and smoothing station 8. Between the application of the reactive hot melt layer 2 and the setting station 8, heat is supplied to the surface of the reactive hot melt layer via an indicated heating device 9 in order to at least keep the reactive hot melt layer semi-fluid.

Three rollers 10 are stored in a rotatable and possibly height-adjustable manner in the setting and smoothing station 8. The rollers are, for example, provided with a polyurethane coating. Above each of the rollers 10, these are in contact with a felting 11, which is wetted with a paraffin-wax-based separating agent 12. Through the rotation of the rollers, the felting provides an even, small amount of the separating agent as a thin layer on the surface of the rollers 10, which pass this on to the reactive hot melt layer 2 during contact with the surface. The surface of the reactive hot melt layer 2 immediately becomes block-free and the smoothing procedure is supported due to the separating agent.

The coated and smoothed parts are transported on from the setting and smoothing station 8 by transport device 5 and are normally stored ca. three to five days for the cross-linking of the reactive hot melt layer 2. After complete cross-linking, the reactive hot melt layer 2 forms a sealing layer that is strongly connected with part 1, which represents a 100% solid body and whose thickness can be set, depending on requirements, between 5 and 150 my during the application. In the case of a board for a parquet floor, further processing of part 1 could occur in the profiling of the tongue-and-groove area of the board.

In conclusion, we would like to point out once again that the method in accordance with the invention is not limited to use on boards for parquet floors, but rather can be used for producing any parts with a sealing layer on the surface.

1. Method for producing a part for a piece of furniture with a sealing layer on the surface, characterized in that the sealing layer is applied as a water-free and solvent-free reactive hot melt layer based on polyurethane and hardened by atmospheric humidity.

2. Method for producing a part made of a wood-like material with a sealing layer on the surface, characterized in that the sealing layer is applied as a water-free and solvent-free reactive hot melt layer based on polyurethane and hardened by atmospheric humidity.

3. Method for producing a part made of steel with a sealing layer on the surface, characterized in that the sealing layer is applied as water-free and solvent-free reactive hot melt layer based on polyurethane and hardened by atmospheric humidity.

4. Method for producing a part made of a nonferrous metal with a sealing layer on the surface characterized in that the sealing layer is applied as water-free and solvent-free reactive hot melt layer based on polyurethane and hardened by atmospheric humidity.

5. Method for producing a part made of plastic with a sealing layer on the surface, characterized in that the sealing layer is applied as water-free and solvent-free reactive hot melt layer based on polyurethane and hardened by atmospheric humidity.

6. Method for producing a part made of paper, cardboard, or papier-mâché with a sealing layer on the surface, characterized in that the sealing layer is applied as water-free and solvent-free reactive hot melt layer based on polyurethane and hardened by atmospheric humidity.

7. Method for producing a part made of a mineral substance with a sealing layer on the surface, characterized in that the sealing layer is applied as water-free and solvent-free reactive hot melt layer based on polyurethane and hardened by atmospheric humidity.

8. Method for producing any part with a sealing layer on its surface that is applied as a water-free and solvent-free reactive hot melt layer based on polyurethane and hardened by atmospheric humidity, characterized in that the reactive hot melt layer is smoothed after application.

9. Method in according with claim 8, characterized in that heat is applied to the surface of the reactive hot melt layer between the application and the smoothing.

10. Method in accordance with claim 8, characterized in that the smoothing of the reactive hot melt layer takes place by means of at least one roller.

11. Method in accordance with claim 10, characterized in that a steel roller is used.

12. Method in accordance with claim 10, characterized in that the roller has a polyurethane coating.

13. Method in accordance with claim 10, characterized in that the roller is wetted with a separating agent during the smoothing.

14. Method in accordance with claim 13, characterized in that the separating agent is applied as a solvent-free and low-viscosity substance based on paraffin wax.

15. Method in accordance with claim 13, characterized in that the separating agent is applied to the roller in a spraying procedure.

16. Method in accordance with claim 13, characterized in that the separating agent is applied to the roller in a vacuum spraying procedure.

17. Method in accordance with claim 13, characterized in that the separating agent is applied to the roller by means of a saturated felting.

18. Part for a piece of furniture with a sealing layer on the surface, characterized in that the sealing layer is a water-free and solvent-free reactive hot melt layer based on polyurethane and hardened by atmospheric humidity.

19. Part made of a wood-like material with a sealing layer on the surface, characterized in that the sealing layer is a water-free and solvent-free reactive hot melt layer based on polyurethane and hardened by atmospheric humidity.

20. Part made of steel with a sealing layer on the surface, characterized in that the sealing layer is a water-free and solvent-free reactive hot melt layer based on polyurethane and hardened by atmospheric humidity.

21. Part made of a nonferrous metal with a sealing layer on the surface, characterized in that the sealing layer is a water-free and solvent-free reactive hot melt layer based on polyurethane and hardened by atmospheric humidity.

22. Part made of plastic with a sealing layer on the surface, characterized in that the sealing layer is a water-free and solvent-free reactive hot melt layer based on polyurethane and hardened by atmospheric humidity.

23. Part made of paper, cardboard, or papier-mâché with a sealing layer on the surface, characterized in that the sealing layer is a water-free and solvent-free reactive hot melt layer based on polyurethane and hardened by atmospheric humidity.

24. Part made of a mineral substance with a sealing layer on the surface, characterized in that the sealing layer is a water-free and solvent-free reactive hot melt layer based on polyurethane and hardened by atmospheric humidity.

25. Any part with a sealing layer on the surface that is a water-free and solvent-free reactive hot melt layer based on polyurethane and hardened by atmospheric humidity, characterized in that the reactive hot melt layer applied to the surface is smoothed.

26. Part in accordance with claim 25, characterized in that the reactive hot melt layer is smoothed by means of at least one roller.

27. Part in accordance with claim 26, characterized in that the reactive hot melt layer is smoothed by means of a steel roller.

28. Part in accordance with claim 26, characterized in that the roller has a polyurethane coating.

29. Part in accordance with claim 26, characterized in that the reactive hot melt layer is smoothed by means of a roller wetted with a separating agent.

30. Part in accordance with claim 29, characterized in that the separating agent is a solvent-free and low-viscosity substance based on paraffin wax.

31. Device for producing parts with a sealing layer on their surface and that contains an application station, a transport device, and a smoothing station.

32. Device in accordance with claim 31, characterized in that a heating device is arranged between the application station and the smoothing station.

33. Device in accordance with claim 31, characterized in that the smoothing station contains at least one roller.

34. Device in accordance with claim 33, characterized in that the roller is a steel roller.

35. Device in accordance with claim 33, characterized in that the roller has a polyurethane coating.

36. Device in accordance with claim 33, characterized in that the roller can be wetted with a separating agent.

37. Device in accordance with claim 36, characterized in that a spraying device is provided for the wetting of the roller with the separating agent.

38. Device in accordance with claim 36, characterized in that a vacuum spraying device is provided for the wetting of the roller with the separating agent.

39. Device in accordance with claim 38, characterized in that a saturated felting is provided for the wetting of the roller with the separating agent.
